(19) United States
(12) Patent Application Publication
(10) Pub. No.: US 2022/0323181 A1
(43) Pub. Date: Oct. 13, 2022

(54) Custom-Designed Chair-Side Fabricated Tunnel Attachments For Moving Teeth

(71) Applicant: President and Fellows of Harvard College, Cambridge, MA (US)

(72) Inventor: Mohamed Ibrahim Masoud, Cambridge, MA (US)

(21) Appl. No.: 17/753,593

(22) PCT Filed: Sep. 25, 2020
(86) PCT No.: PCT/US2020/052936

§ 371 Date: Mar. 8, 2022

Related U.S. Application Data
(60) Provisional application No. 62/908,416, filed on Sep. 30, 2019.

(51) Int. Cl. A61C 7/00; A61C 7/14

(52) U.S. Cl. CPC A61C 7/002; A61C 7/145; A61C 7/141; A61C 7/146

(57) ABSTRACT

A system is directed to repositioning teeth and includes a first three-dimensional image showing an initial position in which a plurality of teeth are unaligned, and a second three-dimensional image shows a final position in which the plurality of teeth are aligned. The system also includes a plurality of structural domes for respective attachment to the plurality of teeth, the plurality of structural domes being customized and formed based on at least one of the first three-dimensional image and the second three-dimensional image. Each chair-side fabricated dome has at least one internal tunnel that is unaligned with an adjacent internal tunnel in the initial position. A continuous wire is inserted through each internal tunnel of the plurality of structural domes and applies a force to the plurality of structural domes such that adjacent internal tunnels are in alignment with each other in the final position.

### CROSS-REFERENCE TO RELATED APPLICATIONS

This application claims priority to and benefit of U.S. Provisional Patent Application Ser. No. 62/908,416, filed on Sep. 30, 2019, which is hereby incorporated by reference herein in its entirety.

### FIELD OF THE INVENTION

The present invention relates generally to custom-designed and chair-side fabricated braces, and, more specifically, to structural attachments that are customized for use on an individual patient.

### BACKGROUND OF THE INVENTION

Present methods of repositioning of teeth, using, for example, aligner trays such as those provided by Invisalign®, suffer from important limitations. For example, although clear aligners are better than braces at achieving certain treatment goals, they are plagued with shortcomings that limit their application to about 50% of orthodontic cases. For example, aligners have a poor ability to achieve root parallelism, especially in cases that involve lower posterior extractions. In another example, aligners have a poor ability to control upper lateral incisor movement, and a poor ability to control the rotation of short round teeth.

Thus, present aligners are not as effective as braces at certain types of movements or in controlling movement of certain teeth. In particular, upper lateral incisor rotations and leveling, uprighting roots, and anterior root torque are probably the most common sources of clinician frustration with aligners.

Accordingly, the present disclosure provides a solution to address the above and other problems. According to one example, the system and method of the present disclosure is used independently or in combination with aligner therapy. According to another example, the system and method of the present disclosure takes advantage of strengths provided by both fixed appliances and clear aligners.

### SUMMARY OF THE INVENTION

According to one embodiment of the present disclosure, a system is directed to repositioning teeth and includes a first three-dimensional image showing an initial position in which a plurality of teeth are unaligned. The system further includes a second three-dimensional image showing a final position in which the plurality of teeth are aligned. The system also includes a plurality of structural domes for respective attachment to the plurality of teeth, the plurality of structural domes being customized and formed based on at least one of the first three-dimensional image and the second three-dimensional image. Each dome of the plurality of structural domes has at least one internal tunnel that is unaligned with an adjacent internal tunnel in the initial position. At least one continuous wire is inserted through each internal tunnel of the plurality of structural domes and applies a force to the plurality of structural domes such that adjacent internal tunnels are in alignment with each other in the final position. The custom design of the structural domes is determined by a clinician's virtual goal for the final position of the teeth, with one benefit of the disclosed system being that the custom-designed attachments, e.g., the structural domes, are fabricated chair-side.

According to another embodiment of the present disclosure, a method for repositioning teeth includes providing a first three-dimensional image showing an initial position in which a plurality of teeth are unaligned. Based on the first three-dimensional image, the method further includes forming a second three-dimensional image showing a final position in which the plurality of teeth are aligned. A plurality of structural domes are formed and customized based on at least one of the first three-dimensional image and the second three-dimensional image, each dome of the plurality of structural domes having at least one internal tunnel that is unaligned with an adjacent internal tunnel in the initial position. A continuous wire is inserted through each internal tunnel of the plurality of structural domes to apply a force to the plurality of structural domes that results in the final position in which adjacent internal tunnels are in alignment with each other.

Additional aspects of the disclosure will be apparent to those of ordinary skill in the art in view of the detailed description of various embodiments, which is made with reference to the drawings, a brief description of which is provided below

### BRIEF DESCRIPTION OF THE DRAWINGS

FIG. 1A is a front perspective view of a structural dome in a first position, according to one embodiment.

FIG. 1B shows the structural dome of FIG. 1A in a second position.

FIG. 2A is a three-dimensional image showing a plurality of teeth in an unaligned position.

FIG. 2B is a three-dimensional image showing structural domes attached to the plurality of teeth of FIG. 2A in an aligned position.

FIG. 3A is a three-dimensional image showing the plurality of teeth of FIG. 2A with individual jigs and respective wire segments.

FIG. 3B is a three-dimensional image showing the individual jigs of FIG. 3A with a continuous wire.

FIG. 4 is a three-dimensional image showing the plurality of teeth of FIG. 3A in the aligned position.

FIG. 5A is a side view of a structural dome having two internal tunnels, according to an alternative embodiment.

FIG. 5B is a perspective view of the structural dome of FIG. 5A.

FIG. 6A is a side view of a structural dome, according to another alternative embodiment.

FIG. 6B is a top perspective view of the structural dome of FIG. 6A.

FIG. 6C is a top view of the structural dome of FIG. 6A.

FIG. 7 shows a plurality of structural domes, in accordance with the embodiment of FIG. 6A, with embedded tubes.

FIG. 8 shows a plurality of structural domes, in accordance with the embodiment of FIG. 6A, with continuous wires inserted through internal tunnels.

FIG. 9 is a side view illustration showing a plurality of teeth prior to alignment treatment.

FIG. 10 is a side view illustration showing the teeth of FIG. 9 in a final position after the alignment treatment.

FIG. 11 is a side view illustration showing tunnel attachments with an inserted wire in the final position of the teeth of FIG. 10.

FIG. 12 is a side view illustration showing the unaligned teeth of FIG. 9 with tunnel attachments prior to alignment of the teeth.

FIG. 13 is a side view illustration showing a wire inserted through the tunnel attachments of FIG. 12 prior to alignment of the teeth.

FIG. 14 is a side view illustration showing the teeth of FIG. 13 in an aligned, final position of the teeth.

FIG. 15 is a top view illustration of a plurality teeth using a mushroom-shaped wire with tunnel attachments, according to an alternative embodiment.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

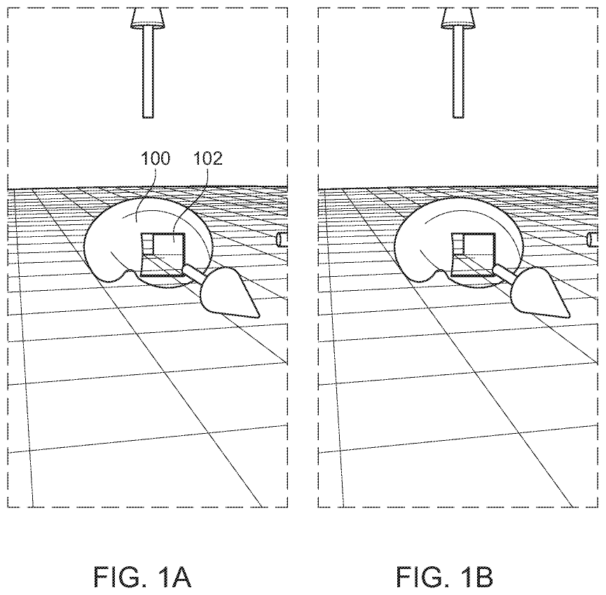

Referring to FIGS. 1A and 1B, the present disclosure relates to tunnel attachments in the form of customized structural domes 100 having internal tunnels 102 that allow a user to move teeth to a digitally predetermined position using wires, e.g., nickel titanium (“NiTi”) wires, that are threaded into the internal tunnels. According to some examples, the internal tunnels are in the form of internal apertures that are completely surrounded within four adjacent internal walls. According to other examples, the internal tunnels are slots having three internal walls and one exposed side without a wall. The structural domes 100 can be used independently and/or in conjunction with clear aligners (e.g., Invisalign® aligners) to accomplish complex movements that aligners cannot effectively perform on their own.

According to one aspect, the disclosed method for teeth repositioning uses customized software that is optionally based on third-party software modified to perform the required functions. Examples of suitable third-party software includes Orchestrate 3D, Ortho Insight 3D, ClinCheck, 3Shape Ortho Analyzer, and SureSmile.

According to another aspect, the present disclosure is generally related to custom computer-designed braces that are made chair-side, or directly on the patient, using custom-designed jigs. The computer-designed braces can be used separately or in conjunction with other aligners. In particular, the custom braces of the present disclosure are chair-side attachments that are custom-made and/or printed for use on an individual patient, in contrast to other attachments that are pre-made molds (i.e., attachments that are not custom-made based on an individual patient). In other words, the custom braces of the present disclosure are custom-designed by an orthodontist for a particular individual patient using an imaging program and method, and then printed in the office (or at a centralized facility). Thus, the custom braces of the present disclosure are not generically manufactured based on molds pre-made at a specialized facility by milling, injection molding, or printing.

According to another aspect, the present disclosure is generally related to an individual jig that is printed or thermoformed from a printed model, while the attachments (e.g., customized structural domes) are made chair-side from high-filled composite resin, which is a posterior tooth-filling material. Optionally, both the individual jig and the respective structural dome are custom-formed chair-side in a clinician's office, and attached to the teeth using a composite resin adhesive.

According to yet another aspect, the present disclosure is generally related to tunnel attachments that can be used during clear aligner therapy and that work towards the same treatment goal as clear aligners. The tunnel attachments allow one or two wires to be threaded through buccal or lingual composite attachments to move teeth to the position determined by the same virtual treatment simulation used to produce the clear aligners. Clinicians can selectively use the tunnel attachments to achieve tooth movements that are difficult to achieve with clear aligners alone.

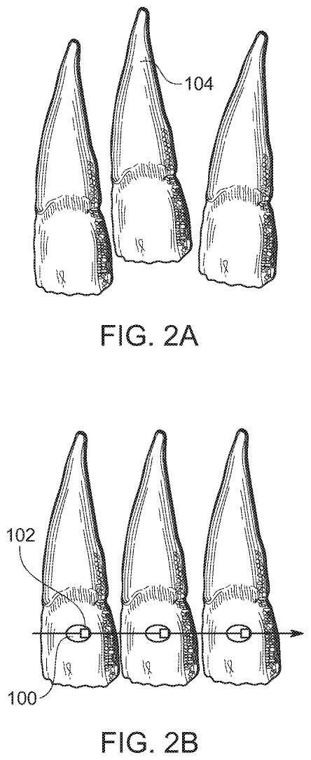

Referring to FIG. 2A, a first three-dimensional image is imported to show an initial position of a plurality of teeth 104 for an individual patient. In other words, the current position of the patient's teeth is scanned. The plurality of teeth 104 include a left tooth, a middle tooth 104b, and a right tooth. The teeth 104 are in an initial, unaligned position, that requires repositioning. In this example, the middle tooth requires repositioning to align with the adjacent left tooth and the adjacent right tooth. Examples that require repositioning include a lateral incisor that is not tracking with clear aligners or a root movement that cannot be accomplished with aligners. The teeth 104 that require repositioning are segmented in the first three-dimensional image.

Referring to FIG. 2B, the teeth 104 are moved to a desired location with a 3D controller. The structural domes 100 are placed on the teeth 104 that require repositioning, as well as on neighboring non-moving teeth so that the internal tunnels 102 align when the teeth 104 are in a final, approved position (as shown in FIG. 2B) that is represented in a second three-dimensional image. In other words, an operator (such as a clinician or orthodontist) virtually aligns the teeth 104 such that the structural domes 100 are positioned with the internal tunnels 102 are aligned in the new tooth position. The shape and orientation of the structural domes 100 is determined by the clinician's goal for the final aligned position of the teeth 104, as represented by the second three-dimensional image.

The structural domes 100, according to an example, have a diameter between about 0.04 inches and about 0.01 inches (e.g., about 1-2.5 millimeters). The internal tunnels 102, according to an example, have an internal shape that ranges in size between about 0.016 inches×0.016 inches to about 0.022 inches×0.028 inches. Thus, the internal tunnels 102 can have a square or a rectangular internal shape. Optionally, the internal tunnels 102 (also referred to as slots) are positioned directly on the respective tooth 104 to minimize the profile. If an even smaller profile is desired, according to an alternative exemplary embodiment, two round tunnels with an 0.016-0.028 inch diameter are used to provide smaller-diameter wires the ability to control tooth movement in three dimensions. This will facilitate easer of wire insertion and provides an enhanced mechanical advantage through a longer lever arm.

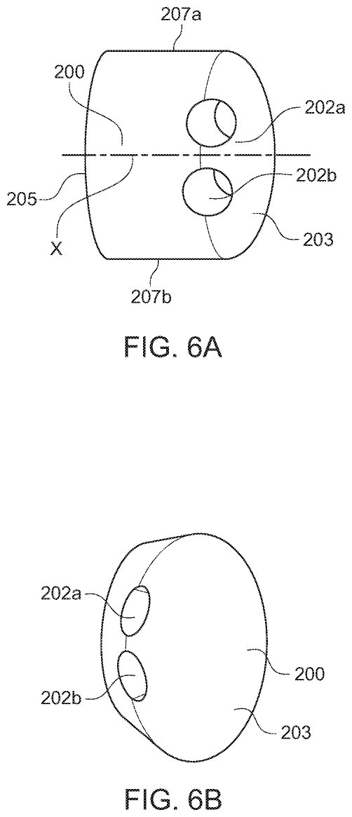

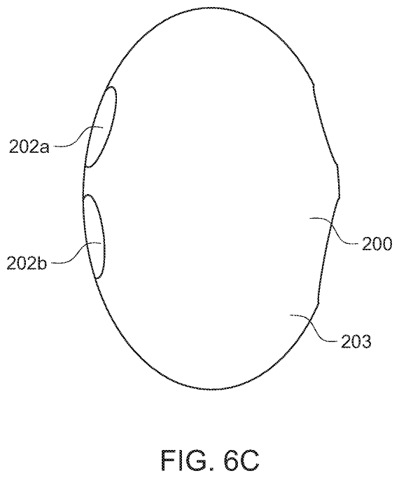

The round wires are optionally made from a composite material, as illustrated in FIG. 6, or are made of a composite material embedded with round metal tubes, as illustrated in FIG. 7A. According to one example, the round metal tubes have a width of about 0.079 inches (about 2 millimeters), with an inner diameter of about 0.019 inches and an outer diameter of about 0.032 inches. According to another example, the wires are metal tubes having a square cross-sectional shape that is approximately 0.019 inches×0.019 inches.

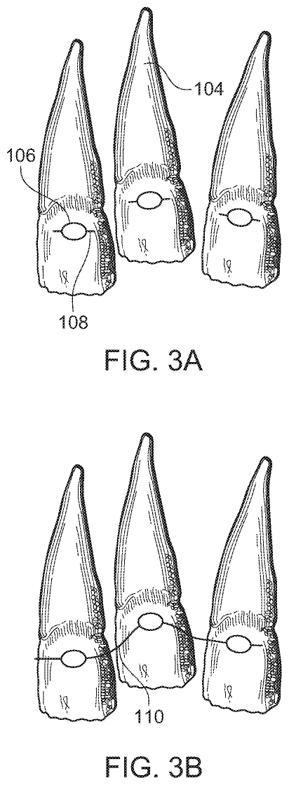

Referring to FIG. 3A, after the virtual repositioning of the teeth 104 a file (such as an .STL file) is generated for custom-forming an individual jig 106 for each tooth 104. According to one example, the jig 106 is generally formed from a plastic material that has the negative of the jig shape 106 represented in FIG. 3A. The jig 106 includes the structural dome 100, with a respective internal tunnel 102, and a holder for a wire segment 108. The jig 106 is formed for each individual tooth 104 to create a respective structural dome 100 chair-side. According to one example, the holder is shaped to accommodate a wire segment 108 of about 0.018 inches×0.018 inches. Optionally, groups of individual jigs 106 are printed and used together. If multiple structural domes 100 are formed simultaneously, the three-dimensional representation of the first, unaligned position is used to make a group jig 106 for all the structural domes 100 that are created chair-side all at once. The shape of the wire segment 108 is used as the hollow space for holding the wire segment 108 in the jig 106 for maintaining the lumen while bonding the structural domes 100.

The jigs 106 are optionally formed with a vacuum thermally-formed material made over 3D printed models with the shape of the tunnel attachment 100 having wire segments 108 or metal tubes. If metal tubes are used, the metal tubes are placed in the jig 106 and bonded with the composite to the teeth, as illustrated in FIGS. 7, 12, and 15.

The generated file is sent, for example, for 3D printing at a dental laboratory or printed in a clinician's office using a desktop 3D printer. The jig 106 is printed directly using resin or is made using a vacuum-formed plastic material on a printed dental model. The structural dome 100 and the shape of the wire segment 108 are incorporated into the printed shape, which is a mold for the structural dome 100 and the wire segment 108.

An operator places the wire segment 108 to fill the internal tunnel 102 and fills any remaining void in the structural dome 100 with a composite, such as an esthetic dental filling material. The wire segment 108 maintains the lumen in the internal tunnel 102 while the composite is being cured and while the structural domes 100 is being fabricated chair-side. Optionally, esthetic wires are used instead of traditional NiTi wires. Optionally, yet, the wire segment 108 is pre-coated with a separating medium (e.g., PAM) to facilitate the removal of the wire segment 108 after curing.

According to an optional double-round wire design, stock tubes having an external diameter of about 0.032 inches and an internal diameter of about 0.019 inches, as illustrated for example in FIGS. 7, 12, and 15, are embedded in the composite using the same holders to maintain the lumen and to provide structural rigidity. In accordance with this optional design, a separating medium is not necessary because the needle segments are attached to the composite. This two-tube design is optionally made entirely from composite with the two round wires being similar to the method used when fabricating the single-tunnel design.

Prior to using the individual jig 106, the tooth 104 is etched and primed. Then, the individual jig 106 is used to bond the structural dome 100 to the respective tooth 104. The structural dome 100 is bonded individually or in groups to the respective teeth 104. Then, the jig 106 is removed, for example, by peeling or cutting open with a high-speed hand piece.

Referring to FIG. 3B, after removal of the jig 106, an operator threads a continuous wire or wires 110 into the internal tunnels 102 of the structural domes 100 for controlling one or more of the teeth 104 that require movement to a predetermined position. At least one continuous wire 110 is optionally a NiTi wire or an esthetic wire. The continuous wire 110 controls movement of the respective tooth 104 in three dimensions, including initial leveling and alignment of the tooth 104. The continuous wire 110 has, for example, a square profile of up to 0.018 inches×0.018 inches to obtain detailed moments including root torque. According to one aspect of the present disclosure, larger continuous wires 110 will operated to achieve a planned root position.

Optionally, one or more of the continuous wire 110 and the structural domes 100 are tooth-colored for improved esthetic appearance. Additionally or alternatively, clear aligners are made with a path of movement cleared to prevent the moment of neighboring teeth 104. For example, a clear aligner grips nonmoving teeth 104 but provides a track for the desired movement to occur while minimizing undesired movements of neighboring teeth 104.

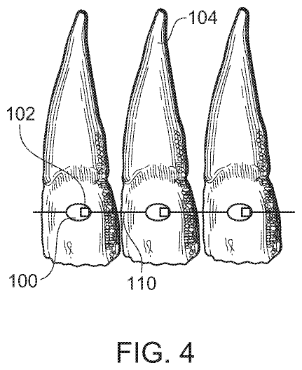

Referring to FIG. 4, the final desired position of the teeth 104 is achieved when the continuous wire 110 becomes passive. In this predetermined position, the internal tunnels 102 of the structural domes 100 are aligned with each other, e.g., the internal tunnel 102 of the left tooth 104 is aligned with the internal tunnel 102 of the middle tooth.

Optionally, according to an alternative aspect of the present disclosure, a structural dome has a hook for attachment to an elastic or a power chain. Optionally yet, the system of the present disclosure is used on labial and/or lingual surfaces of the teeth to increase esthetics.

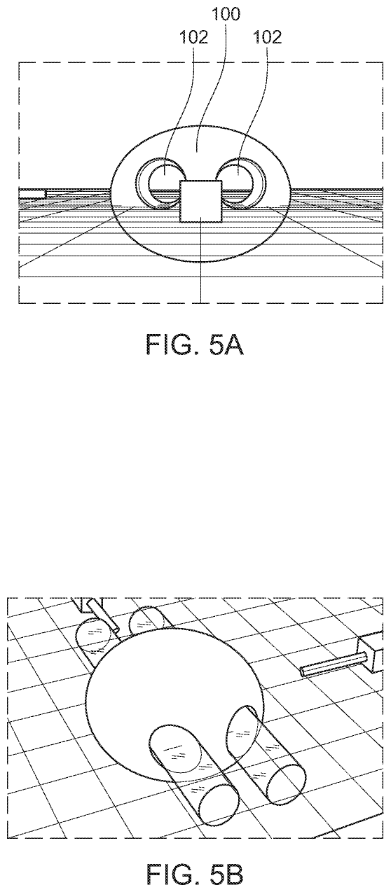

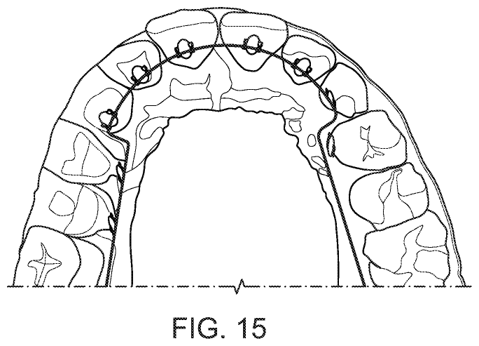

Referring to FIGS. 5A and 5B, according to an alternative embodiment, the structural dome 100 has two internal tunnels 102 that facilitate ease of wire insertion for the clinician and provide a mechanical advantage with a longer lever arm. The internal tunnels 102, according to one example, provide lumens with a diameter of about 0.016-0.020 inches depending on the size of the wires or metal tubes used to maintain the space. Correspondingly, stock tubes having an internal diameter of about 0.016 inches and an external diameter of about 0.032 inches are used to maintain the lumens of the internal tunnels 102 and are embedded in a composite to provide additional slot rigidity. Optionally, two round Niti wires with a diameter ranging between about 0.012 inches and about 0.020 inches are inserted, respectively, into the internal tunnels 102 (having a diameter of about 0.019 inches in the example illustrated in FIG. 15) to obtain the desired movements.

Referring generally to FIGS. 6A-6C, according to another alternative embodiment, a structural dome 200 has two round internal tunnels 202a, 202b near a top surface 203 that is generally curved. Referring specifically to FIG. 6A, the structural dome 200 further has a bottom surface 205 that is generally flat and that is intended for attachment to a respective tooth. The tunnels 202a, 202b are positioned generally symmetrically relative to a symmetry line X that is centrally positioned between two peripheral sides 207a, 207b of the structural dome 200.

Referring to FIG. 7, the structural dome 200 is affixed to a respective tooth 204 and has two tubes 209a, 209b that are embedded, respectively, within the tunnels 202a, 202b. According to one aspect of this embodiment, the tubes 209a, 209b are metal tubes that are embedded in a composite material of the structural dome 200.

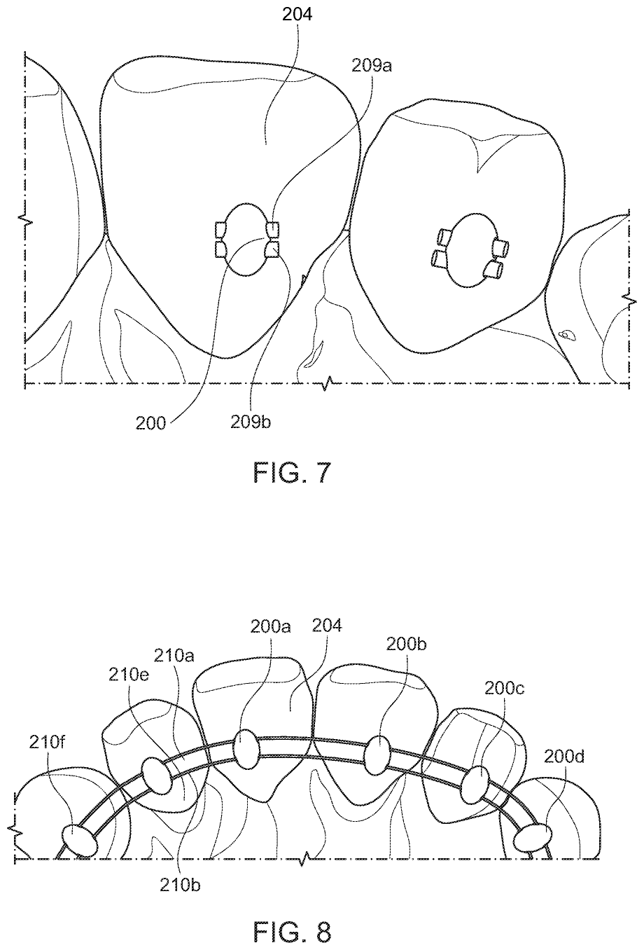

Referring to FIG. 8, a pair of continuous wires 210a, 210b are inserted respectively through the tubes of each of a plurality of domes 200a-200f. Each dome 200a-200f is affixed to a respective tooth 204 to achieve a desired repositioning in accordance with the disclosure provided above in which computer-designed chair-side fabricated attachments (i.e., structural domes) are provided for orthodontic tooth movement.

According to one options feature, jigs for multiple teeth are printed or thermoformed using 3D printed models of initial malocclusion with tunnel attachments.

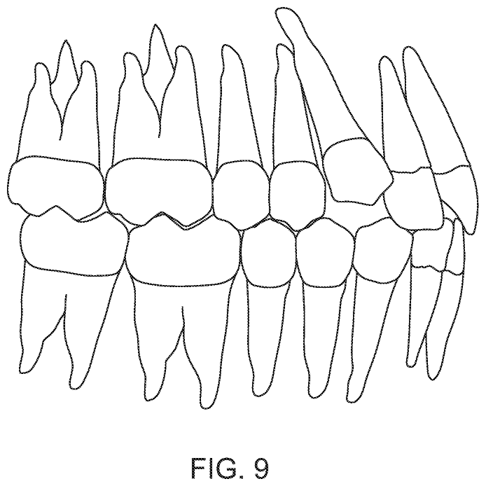

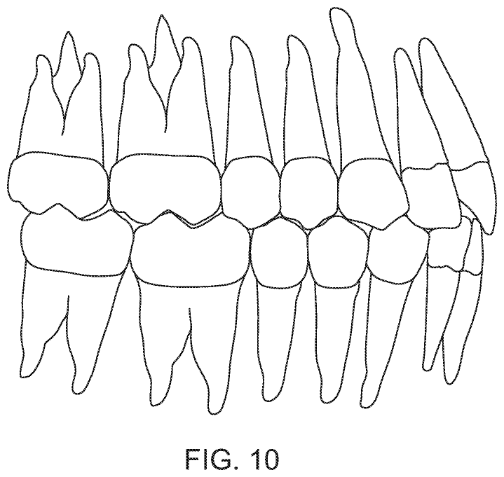

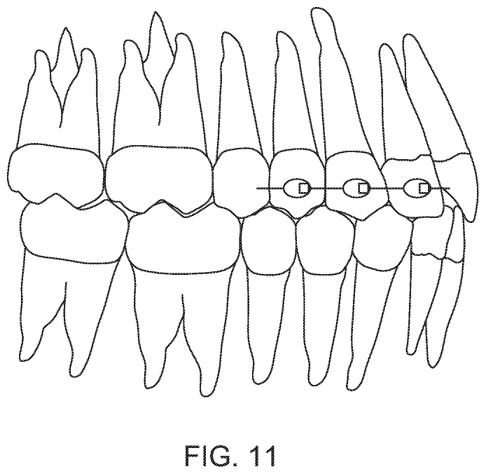

Referring generally to FIGS. 9-14, an exemplary treatment process illustrates extruding an upper right canine and moving the root mesially, which would be challenging to achieve via aligners alone. A virtual plan would be set up the same or similarly to using a regular aligner case. A clinician or provider decides, as illustrated in FIG. 11, where it would be beneficial to use tunnel attachments. A treatment application places the tunnel attachments on selected teeth such that a wire would passively go through holes of the tunnel attachments when the teeth are in a final, aligned position. A user can then modify the position of the assembly of tunnel attachments for aesthetics and/or function.

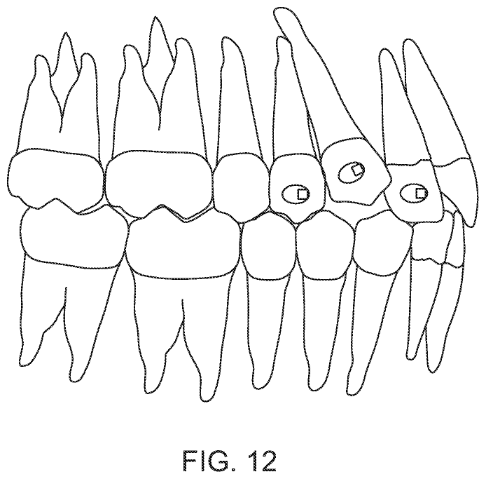

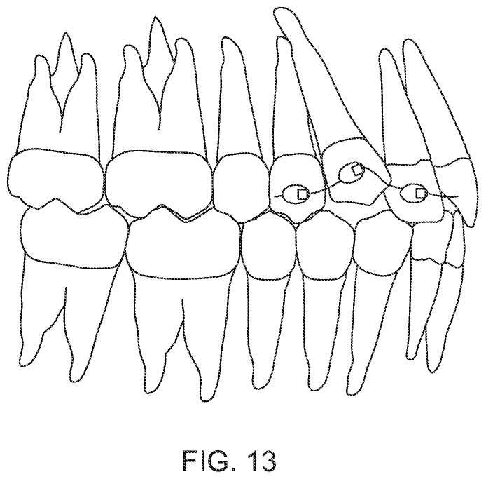

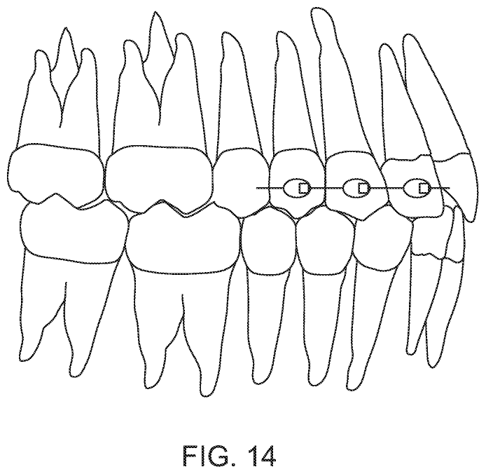

The tunnel attachments are bonded similar to how conventional attachments are bonded, using an attachment template with a place holder for a wire slot (as illustrated in FIG. 12). A round NiTi wire is then threaded through the tunnel attachments (as illustrated in FIG. 13), but, alternatively, two wires can be used if torque is needed. The tunnel attachments have the wire area blocked out and a flowable composite is used on wire ends for patient comfort. The wire or wires in the tunnel attachments and the aligners work together to achieve the exact same alignment goal (as illustrated in FIG. 14). The tunnel attachments illustrated in FIGS. 9-14 can be similar or identical to any of the tunnel attachments described above.

Referring to FIG. 15, in reference to examples of lingual or palatal tunnel attachments, a stock mushroom-shaped NiTi wire is sued for lingual or palatal tuner attachments. The tunnel attachments illustrated in FIG. 15 can be similar or identical to any of the tunnel attachments described above.

Benefits of the above-described tunnel attachments include an improved lateral incisor tracking, ability to extrude or upright individual teeth, ability to treat impactions, and ability to selectively use tunnel attachments around extraction sites. Other benefits of the above-described tunnel attachments include being invisible if placed on the palatal/lingual, ability to change aligners every 4 days if worn 20 hours a day, and ability to change aligners every 7 days if worn just at night.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention. It is also contemplated that additional embodiments according to aspects of the present invention may combine any number of features from any of the embodiments described herein.

1. A structural lattice comprising:
a rectangular base defined by four periphery beams and including two non-diagonal beams that divide the rectangular base in four quadrants; and
a diagonal reinforcement strut system overlaid on the rectangular base and having at least two intersecting sets of diagonal beams forming an open-and-closed cell architecture.

2. The structural lattice of claim 1, wherein one of the two intersecting sets of diagonal beams is a first set of diagonal beams, the first set of diagonal beams including a first beam that is parallel to a second beam.

3. The structural lattice of claim 2, wherein the first beam and the second beam are symmetrically positioned over one of the four quadrants.

4. The structural lattice of claim 2, wherein another one of the two intersecting sets of diagonal beams is a second set of diagonal beams, the second set of diagonal beams including a respective first beam that is parallel to a respective second beam.

5. The structural lattice of claim 4, wherein the first set of diagonal beams intersects the second set of diagonal beams at a perpendicular angle.

6. The structural lattice of claim 4, wherein the respective first beam and the respective second beam are symmetrically positioned over one of the four quadrants.

7. The structural lattice of claim 6, wherein the first beam and the second beam of the first set of diagonal beams are symmetrically positioned over a same one of the four quadrants as the respective first beam and the respective second beam of the second set of diagonal beams.

8. The structural lattice of claim 1, wherein at least one of the four quadrants is an open cell having an equilateral octagon shape, the equilateral octagon shape being defined by two of the four periphery beams, the two non-diagonal beams, and four beams of the at least two intersecting sets of diagonal beams.

9. The structural lattice of claim 1, wherein the rectangular base and the diagonal reinforcement strut system form at least a structural portion of a building, a bridge, an aerospace structure, an automotive structure, a crane, or a power transmission structure.

10. The structural lattice of claim 1, wherein the diagonal reinforcement strut system is welded to the rectangular base.

11. A periodic structural lattice comprising:
a plurality of non-diagonal reinforcing struts forming a base structure of the periodic structural lattice, the base structure being defined by a base periphery, the plurality of non-diagonal reinforcing struts having a first volume of material; and
a plurality of diagonal reinforcing struts coupled to the base structure and having a predetermined cross-sectional geometry forming open and closed cells with the plurality of non-diagonal reinforcing struts, the plurality of diagonal reinforcing struts having positive and negative slopes relative to the plurality of non-diagonal reinforcing struts, the plurality of diagonal reinforcing struts being spaced apart at predetermined intervals within the base periphery and having a second volume material, the first volume of material and the second volume of material being less than a total volume of the periodic structural lattice that includes the open and closed cells.

12. The periodic structural lattice of claim 11, wherein the plurality of non-diagonal reinforcing struts have a round cross-section.

13. The periodic structural lattice of claim 11, wherein the plurality of non-diagonal reinforcing struts have a square cross-section.

14. The periodic structural lattice of claim 11, wherein the base periphery has four periphery beams forming a rectangular shape.

15. The periodic structural lattice of claim 14, wherein the four periphery beams have a round cross-section.

16. The periodic structural lattice of claim 14, wherein the four periphery beams have a square cross-section.

17. The periodic structural lattice of claim 11, wherein the plurality of diagonal reinforcing struts includes a first pair of parallel beams and a second pair of parallel beams, the first pair of parallel beams intersecting the second pair of parallel beams at a predetermined angle.

18. The periodic structural lattice of claim 17, wherein the predetermined angle is 90°.

19. The periodic structural lattice of claim 11, wherein the positive and negative slopes are formed by perpendicularly intersecting pairs of the plurality of non-diagonal reinforcing struts.

20. The periodic structural lattice of claim 11, wherein the base structure and the plurality of diagonal reinforcing struts form a repeating sub-unit of at least a structural portion of a building, a bridge, an aerospace structure, an automotive structure, or a power transmission structure.
